(19) United States
(12) Patent Application Publication
(10) Pub. No.: US 2003/0168224 A1
(43) Pub. Date: Sep. 11, 2003

(54) Novel phosphorous-nitrogen compounds used as fireproofing agents in theroplastic molding materials and the production thereof

(76) Inventors: Eva Freudenthaler, Ludwigshafen (DE); Alexandra Brand, Darmstadt (DE); Hans-Josef Sterzel, Dannstadt-Schauernheim (DE); Jochen Engelmann, Neustadt (DE); Martin Klatt, Mannheim (DE)

Correspondence Address: KEIL & WEINKAUF, 1350 CONNECTICUT AVENUE, N.W., WASHINGTON, DC, 20036, US

(21) Appl. No.: 10/296,253

(22) PCT Filed: May 22, 2001
(86) PCT No.: PCT/EP01/05899

(30) Foreign Application Priority Data
May 22, 2000 (DE) 10025291.5

(51) Int. Cl. A62C 2/00

(52) U.S. Cl. 169/43

(57) ABSTRACT

In the process for preparing phosphorus-nitrogen compounds by reacting phosphorus sulfides with an amino component which

has at least one nitrogen atom having at least two hydrogen atoms, or

has at least two nitrogen atoms having at least one hydrogen atom,

the desired phosphorus-nitrogen compounds are formed at a temperature Tₘₐₓ≧200° C.

These compounds are preferably used as flame retardants in thermoplastic molding compositions which then may also comprise, inter alia, besides a thermoplastic polymer,

a nitrogen compound,

fillers,

lubricants,

conventional additives, and/or

conventional impact modifiers.

The invention relates to novel phosphorus-nitrogen compounds, to a process for their preparation, to their use as flame retardants in thermoplastic molding compositions, and also to thermoplastic molding compositions comprising these novel phosphorus-nitrogen compounds.

From the reaction of urea with phosphorus pentasulfide C. V. Kutschig (Monatsh. Chem. 9 (1888) 406 to 413) and F. V. Hemmelmayr (Monatsh. Chem. 26 (1905) 765 to 782) obtained the phosphorus-nitrogen compound ammonium 4,6-dioxo-2-thiooxohexahydro-1,3,5,2-λ⁵-triazaphosphorinane-2-thiolate. Here, the reaction of urea with phosphorus pentasulfide took place with a molar ratio P₄S₁₀ to urea of 1:3.7 on a boiling waterbath, i.e. at from 80 to 90° C. The product obtained was highly soluble in hot water and had a decomposition temperature of 230° C.

U.S. Pat. No. 4,061,589 discloses the use of 1,3,5-triazine 4,6-diketo 2-dithio ammonium phosphamate and 1,3,5-triazine 4,6-dithio 2-dithio ammonium phosphamate as corrosion inhibitors in cooling-water systems. These phosphorus-nitrogen compounds are prepared by reacting urea compounds with phosphorus pentasulfide at 100° C. The product is obtained by extraction with cold water and decomposes above 260° C.

DE-A 24 17 991 relates to the preparation of thiophosphoramides, which are used as antioxidants for polymers. They are prepared by reacting phosphorus pentasulfide with primary or secondary aromatic amines at from 100 to 150° C., followed by addition of aliphatic or aromatic alcohol or amine at from 100 to 150° C. in an organic solvent. The thiophosphoramides are obtained by crystallization after distilling off the organic solvent.

DD-A 203 724 relates to the preparation of ammonium 4,6-dioxo-2-thiooxohexahydro-1,3,5,2-λ⁵-triazaphosphor-inane-2-thiolate from phosphorus pentasulfide and urea at from 90 to 130° C. The yield of desired product is temperature-dependent, the yield increasing at higher temperatures. However, the spontaneous decomposition of urea begins at 140° C., reducing the yield. The products obtained are used as intermediates for preparing biocides or as constituents of lubricants or of corrosion inhibitors.

It is an object of the present invention to prepare novel phosphorus-nitrogen compounds which, when compared with the phosphorus-nitrogen compounds known from the prior art have in particular low water-solubility and high thermal stability. The novel phosphorus-nitrogen compounds are to be suitable as flame retardants for thermoplastic molding compositions.

We have found that this object is achieved using a process for preparing phosphorus-nitrogen compounds by reacting phosphorus-sulfides with an amino component which

has at least one nitrogen atom having at least two hydrogen atoms, or

has at least two nitrogen atoms having at least one hydrogen atom.

The novel process then comprises forming the desired phosphorus-nitrogen compounds at a temperature Tₘₐₓ≧200° C.

This temperature Tₘₐₓ is the highest temperature arising in the novel process. When carrying out the novel process in more than one stage, the temperature Tₘₐₓ is reached here in at least one stage. The temperature Tₘₐₓ is preferably from 200 to 350° C., particularly preferably from 280 to 320° C.

The phosphorus-nitrogen compounds obtained with the aid of the novel process have high thermal stability. This means that no decomposition is observed over a period of at least 15 min. at temperatures within the range from, in general, room temperature to 300° C.

At the same time, the phosphorus-nitrogen compounds prepared by the novel process have very low water-solubility. The water solubility of these compounds is generally from 0 to 5 g/l, preferably from 0 to 0.5 g/l, particularly preferably from 0 to 0.1 g/l. The phosphorus-nitrogen compounds are therefore particularly suitable for use in locations where resistance to moisture is a major requirement.

Without adopting any particular theory, the low water-solubility may be due to the formation of highly crosslinked polymeric structures in the phosphorus-nitrogen compounds obtained according to the invention. The formation of the highly crosslinked polymeric structures is a result of the high temperatures Tₘₐₓ used in the novel process. In cases where the amino components used have two or more hydrogen atoms bonded to one nitrogen atom, crosslinking can take place to give highly crosslinked phosphorus-nitrogen compounds with development of P—N—(R)—P bridges. In cases where the amino components used have at least two nitrogen atoms with at least one hydrogen atom bonded to each of these, the crosslinking also takes place via the molecular chain of the amino component with development of P—N—R—N—P bridges. For the purposes of the present invention, R here is a molecular moiety corresponding to the radical of the respective amino component used.

The amino component used in the novel process has preferably been selected from primary aliphatic or aromatic amines, primary or secondary diamines, diimines, primary or secondary ammonium salts, amides of organic or of inorganic acids, hydrazines, hydrazides, semicarbazides, semicarbazones, urea, dicyandiamide, melamine, guanidine or its salt (guanidinium carbonate) or mixtures of these.

Particularly suitable examples of the appropriate groups are given below:

Primary Aliphatic or Aromatic Amines

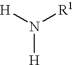

R¹=H or an aliphatic or aromatic organic radical preferably having from 1 to 12 carbon atoms.

Primary or Secondary Diamines

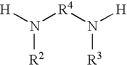

R² and R³=H or an aliphatic or aromatic organic radical preferably having from 1 to 12 carbon atoms.

R⁴=a hydrocarbon chain preferably having from 1 to 12 carbon atoms.

Diimines

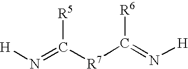

R⁵ and R⁶=H or an aliphatic or aromatic organic radical preferably having from 1 to 12 carbon atoms.

R⁷=a hydrocarbon chain preferably having from 1 to 12 carbon atoms.

Primary or Secondary Ammonium Salts

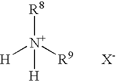

R⁸ and R⁹=H or any desired aliphatic or aromatic organic radical preferably having from 1 to 12 carbon atoms.

X=any desired anion, preferably halogen-free.

Amides of Organic or of Inorganic Acids (e.g. Carboxamides or Sulfonamides)

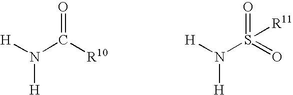

R¹⁰ and R¹¹=H or any desired aliphatic or aromatic organic radical preferably having from 1 to 12 carbon atoms.

Hydrazines

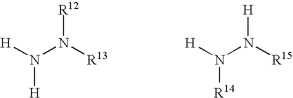

R¹², R¹³, R¹⁴ and R¹⁵=H or any desired aliphatic or aromatic organic radical preferably having from 1 to 12 carbon atoms.

Hydrazides

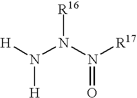

R¹⁶ and R¹⁷=H or any desired aliphatic or aromatic organic radical preferably having from 1 to 12 carbon atoms.

Semicarbazides

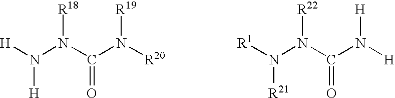

R¹⁸, R¹⁹, R²⁰, R²¹ and R²²=H or any desired aliphatic or aromatic organic radical preferably having from 1 to 12 carbon atoms.

Semicarbazones

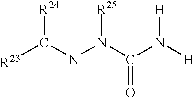

R²³, R²⁴ and R²⁵=H or any desired aliphatic or aromatic organic radical preferably having from 1 to 12 carbon atoms.

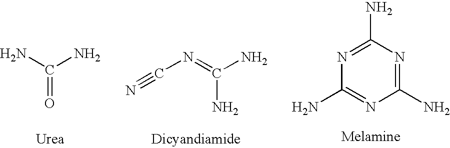

Guanidine, e.g. in the Form of its Salt Guanidinium Carbonate

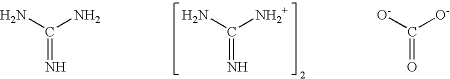

It is preferable to use amino components selected from urea, dicyandiamide, melamine, guanidine or its salt, in particular guanidinium carbonate, or mixtures of these.

The phosphorus sulfides used are preferably monomeric phosphorus sulfides of composition P₄Sₙ, where n is from 3 to 10, or mixtures of these. Use of P₄S₁₀ or P₄S₃ is preferred, and use of P₄S₁₀ is particularly preferred. For the purposes of the present invention, P₄S₁₀ (tetraphosphorus decasulfide) is the same compound as phosphorus pentasulfide (P₂S₅). The form in which this substance in present as a solid is P₄S₁₀, it melts at 288° C. and boils at 514° C., forming a yellow vapor composed of molecules whose mass corresponds to P₂S₅.

The phosphorus sulfides used in the novel process may be prepared in an upstream reaction, by melting red phosphorus and sulfur together in a carbon dioxide atmosphere. This usually gives mixtures of different phosphorus sulfides which, without any further purification or separation, can be reacted with the amino component. It is also possible for the appropriate phosphorus sulfide or the phosphorus sulfide mixtures to be formed in situ during the reaction with the amino component.

The ratio of the sulfur atoms present in the phosphorus sulfides to the condensable nitrogen groups present in the amino components is generally from 1:0.5 to 1:10, preferably from 1:1 to 1:5, particularly preferably from 1:2 to 1:3. This ratio of sulfur atoms to condensable nitrogen groups gives a particularly high degree of crosslinking in the desired phosphorus-nitrogen compounds and thus very low water-solubility in these compounds. Depending on the ratio of the appropriate phosphorus sulfide to the amino component used, and on the reaction temperature, the sulfur may be completely or to some extent eliminated during the condensation in the form of gaseous compounds, e.g. H₂S, COS and/or CS₂, or in the form of sublimable compounds. The novel process, which is carried out at ≧200° C. therefore gives a water-insoluble product with a low residual sulfur content.

The reaction of the novel process generally takes place in an inert gas atmosphere. For the purposes of the present invention, inert gas is any gas which does not enter into any chemical reaction with the starting materials, intermediates or final products. Suitable inert gases are Ar, N₂, He and CO₂, particularly preferably N₂.

In one preferred embodiment the novel process embraces the following steps:

a) heating the phosphorus sulfide and the amino component together to the temperature T₁ under an inert gas, and

b) slowly heating the resultant reaction mixture to Tₘₐₓ≧200° C. under an inert gas.

The temperature T₁ in step a) is generally from 90 to 300° C., preferably from 95 to 250° C., particularly preferably from 180 to 250° C. During the reaction there is usually some evolution of gas, e.g. H₂S, COS and/or CS₂. The end of step a) can be recognized by the cessation of this gas evolution. The reaction times here depend, inter alia, on the feed rate of the amino component.

The reaction mixture obtained at the end of step a) is usually solid.

In the following step b), the resultant reaction mixture, if desired comminuted, is annealed at a temperature Tₘₐₓ≧200° C., preferably from 200 to 250° C., particularly preferably from 280 to 350° C.

Step b) is carried out under one of the abovementioned inert gases.

Any odor of hydrogen sulfide which may attach to the resultant phosphorus-nitrogen compounds, depending on their sulfur content, may be removed by adding in general from 2 to 20% by weight, preferably from 5 to 15% by weight, of zinc oxide in step b). Adding zinc oxide does not impair the properties of the phosphorus-nitrogen compounds, in particular their flame retardancy.

Another way of removing any odor attaching to the phosphorus-nitrogen compounds is to oxidize the phosphorus-nitrogen compounds with an oxidizing gas, such as air, oxygen, NO₂, preferably air, at in general from 50 to 300° C., preferably at from 100 to 300° C.

Any commonly used type of reactor is generally suitable as a reaction vessel for carrying out the process of the invention. Particular preference is given to a mixing vessel with a stirrer which passes close to the wall, and to paddle dryers and Diskotherm reactors, by means of which the product which forms, where appropriate as a solid, can also be ground and homogenized as the reaction in step a) proceeds.

The present invention also provides phosphorus-nitrogen compounds which can be prepared by the process of the invention. These compounds have high thermal stability, and also low water-solubility.

They are highly suitable for use as flame retardants, in particular in thermoplastic molding compositions. The present invention therefore also provides the use of the phosphorus-nitrogen compounds of the invention as flame retardants in thermoplastic molding compositions.

There is a major requirement for halogen-free flame retardants such as the phosphorus-nitrogen compounds of the invention, since the halogen-containing flame retardants commonly used can release toxic and/or corrosive compounds in the event of a fire, for example dioxins and halogenated hydrocarbons. Red phosphorus, which is commonly used, has the disadvantage of intrinsic color.

The high thermal stability of the phosphorus-nitrogen compounds of the invention, which do not decompose over a period of at least 15 minutes at in general up to 300° C., means that the compounds can be incorporated into high-melting molding compositions, such as nylon-6,6 and polybutylene terephthalate without any decomposition of the phosphorus-nitrogen compounds.

The phosphorus-nitrogen compounds of the invention also have a pale instrinsic color, and the color of the desired final products is therefore not impaired by incorporating the phosphorus-nitrogen compounds of the invention. The polymer-compatibility of the phosphorus-nitrogen compounds of the invention is high, and the compounds are therefore distributed uniformly within the thermoplastic molding compositions.

The phosphorus-nitrogen compounds of the invention are effective both in unreinforced polymers and in polymers reinforced with fillers. One of the reasons for the high effectiveness of the phosphorus-nitrogen compounds of the invention is their high phosphorus-nitrogen content, which is in total generally >50%, preferably >55%, particularly preferably >60%, but at least 35%.

Another advantage of the phosphorus-nitrogen compounds of the invention when used as flame retardants in thermoplastic molding compositions is their very low water-solubility.

This prevents elution or migration of the flame retardant, in particular when products produced from the thermoplastic molding compositions comprising the phosphorus-nitrogen compounds are used in conditions of wet weathering. Oxidation and/or hydrolysis of any flame retardant used in the thermo plastic molding compositions could lead to partial breakdown of the thermoplastic molding compositions, but these processes can be avoided by using the phosphorus-nitrogen compounds of the invention.

When used as flame retardants, the phosphorus-nitrogen compounds of the invention are suitable for incorporation into any desired thermoplastic polymer.

The present invention therefore also provides thermoplastic molding compositions comprising:

a) from 5 to 99% by weight, preferably from 10 to 80% by weight, particularly preferably from 30 to 80% by weight, of a thermoplastic polymer, as component A,

b) from 1 to 40% by weight, preferably from 5 to 35% by weight, particularly preferably from 10 to 30% by weight, of a phosphorus-nitrogen compound of the invention, as component B,

c) from 0 to 30% by weight, particularly preferably up to 20% by weight, of a nitrogen compound, as component C,

d) from 0 to 50% by weight, preferably from 1 to 50% by weight, particularly preferably from 20 to 40% by weight, of fillers, as component D,

e) from 0 to 5% by weight, preferably from 0.01 to 3% by weight, of lubricants, as component E,

f) from 0 to 10% by weight, preferably up to 8% by weight, particularly preferably up to 3% by weight, of conventional additives, and

g) from 0 to 30% by weight, preferably up to 25% by weight, particularly preferably up to 20% by weight, of conventional impact modifiers, as component G.

Component A

Suitable thermoplastic polymers are either polycondensates or else polymers or polyadducts. Suitable thermoplastic polycondensates are polyamides, particularly preferably nylon 6,6, nylon-6, nylon-11, nylon-12, nylon-4,6, and also copolyamides, such as nylon-6/6T, nylon-6,6/6T, and polyamides built up from caprolactam and hexamethylene adipamide and, if desired, from another comonomer. Other suitable thermoplastic polycondensates are polycarbonates, polyesters, preferably polyterephthalates, such as polyethylene terephthalate or polybutylene terephthalate, polyphenylene oxides, polysulfones and polyvinyl acetates. Suitable thermoplastic polymers are polyolefins, in particular polyethylene, polypropylene, poly-1-butene, poly-4-methyl-1-pentene, and also polyvinyl chloride, polyvinylidene chloride, polymethyl methacrylate, polyacrylonitrile, polystyrene, impact-modified polystyrene, polyacetals, polyvinyl alcohols, polyvinyl acetate and poly-p-xylylene. Suitable thermoplastic polyadducts are linear polyurethanes. Component A is particularly preferably a thermoplastic polycondensate, in particular a polyamide or a polyester. It is very particularly preferably nylon-6,6, nylon-6, nylon-6/6T, nylon-6,6/6T, nylon-6/6,6 or polyethylene terephthalate or polybutylene terephthalate. Nylon-6,6, nylon-6, nylon-6/6,T, nylon-6,6/6,T, nylon-6/6,6 and also polyethylene terephthalate and polybutylene terephthalate are relatively high-melting polymers. Processing to give thermoplastic molding compositions therefore requires the use of components which do not decompose at the high process temperatures required. The phosphorus-nitrogen compounds of the invention, which are thermally very stable, are therefore highly suitable for use as flame retardants in thermoplastic molding compositions of this type.

Other suitable thermoplastic polymers are styrene-acrylonitrile copolymers (SAN), α-methylstyrene-acrylonitrile copolymers, styrene-methyl methacrylate copolymers and styrene-maleic anhydride copolymers, and also acrylonitrile-butadiene-styrene polymers (ABS) and acrylonitrile-styrene-acrylate polymers (ASA).

Component B

Component B is a phosphorus-nitrogen compound of the invention, which can be prepared by the process of the invention.

Component C

Component C is a nitrogen compound selected from guanidine salts, allantoin compounds, ammonium polyphosphates, melamine and melamine compounds, preferably melamine cyanurate.

Component D

Suitable fillers are carbonates, in particular calcium carbonate, silicates, such as talc, clay and mica, siliceous earth, calcium sulfate, barium sulfate, aluminum hydroxide, glass fibers and glass beads, and also wood flour and cellulose powder.

Component E

Particularly suitable lubricants are fatty amides and fatty esters, which may in each case be mono- or polyfunctional, salts of fatty acids, preferably zinc salts of fatty acids or calcium stearate, salts or esters of montanic acid, esters of montanic acid being preferred, in particular those having C₁₂-C₁₆-alkyl chains, and polyalkylene waxes and modified alkylene waxes, in particular polyethylene waxes and partially oxidized polyethylene waxes.

Component F

Commonly used additives are stabilizers, nucleating agents, pigments, dyes, plasticizers and antidrop agents.

Component G

Particularly suitable commonly used impact modifiers are ethylene-propylene rubber (EPM) and ethylene-propylene-diene rubbers (EPDM), in each case preferably grafted with reactive groups (carboxylic acids, anhydrides) and also copolymers of ethylene with acrylic acid and/or methacrylic acid and/or with esters of these acids.

The thermoplastic molding compositions may be prepared by mixing components A and B and also, if desired, C to G at elevated temperatures, thus melting component A. These thermoplastic molding compositions comprising the phosphorus-nitrogen compounds of the invention as flame retardants may be used to produce moldings, films or fibers.

Use of the phosphorus-nitrogen compounds of the invention as flame retardants in thermoplastic molding compositions is compliant with the flame retardancy requirements at least of UL 94 V-2, preferably UL 94 V-0. UL here means Underwriters Laboratories, V-2 means an afterflame time per flame application of ≦30 s and a total afterflame time for 10 flame applications of ≦250 s. V-0 means an afterflame time per flame application of ≦10 s and a total afterflame time of ≦50 s. V-1 (see Table 1) means the same afterflame time and total afterflame time as for V-2 but no formation of flaming drops.

The examples below further illustrate the invention.

### EXAMPLES

Preparation of the Phosphorus-Nitrogen Compounds

### Example 1

A mixture of 200 g of phosphorus pentasulfide and 270 g of urea was heated in a glass flask under nitrogen at 235° C. for 5 hours. During this process a homogeneous melt was first formed, with evolution of gas, and at increased temperature this foamed with vigorous evolution of gas and became solid. After cooling, the reaction product was ground and annealed for 5 hours under nitrogen at 350° C. This gave 199 g of product (24.8% by weight phosphorus, 37.7% by weight nitrogen, 20.8% by weight oxygen, 12.0% by weight carbon, 0.3% by weight sulfur). After 5 hours the solubility in water was 0.81 g/1000 g.

### Example 2

A mixture of 240 g of phosphorus pentasulfide and 454.2 g of dicyandiamide was heated in a glass flask under nitrogen at 96° C. for 15 minutes. During this process a foam-like mass was formed, and rapidly hardened. After cooling, the product was ground and slowly heated to 350° C. under nitrogen and annealed for 8 hours at 350° C. This gave 439 g of product (13.8% by weight phosphorus, 55.9% by weight nitrogen, 21.9% by weight carbon, 4.6% by weight sulfur). After 5 hours the solubility in water was 0.17 g/1000 g.

### Example 3

100 g of phosphorus pentasulfide in a paddle drier (volume 0.77 l) were preheated to 200° C. A total of 188 g of dicyandiamide were then fed in portions over a period of 3.5 hours. The reaction temperature here was 250° C. Once the reaction had ended, 10 g of zinc oxide were added and the product annealed for 2 hours at 300° C. This gave 143 g of product.

Use of the Resultant Phosphorus-Nitrogen Compounds as Flame Retardants

The components were mixed in a twin-screw extruder at 280° C. (nylon-6,6) or 260° C. (polybutylene terephthalate). For the UL 94 fire tests, fire specimens of thickness 1.6 mm were injection molded. The fire tests were carried out to the UL specification after the usual conditioning (2 days at 23±2° C. and atmospheric humidity of 50±5% and 7 days at 70±1° C. and then cooling in a dessicator). For the tests, 5 fire specimens were each exposed twice for 10 s to flame application from a gas burner (flame height 20±1 mm) and the afterflame time measured.

Components:

Component A1:

Nylon-6,6 with a viscosity number of 147 ml/g (measured with an Ubbelohde capillary viscometer in 0.5% strength solution in 96% strength H₂SO₄).

Component A2:

Polybutylene terephthalate with a viscosity number of 130 ml/g (measured with an Ubbelohde capillary viscometer in 0.5% strength solution in dichlorobenzene/phenol 1/1).

Component B1:

Phosphorus-nitrogen compound based on Synthesis Example 1.

Component B2:

Phosphorus-nitrogen compound based on Synthesis Example 2.

Component B3:

Phosphorus-nitrogen compound based on Synthesis Example 3.

Component B4 (Comparative Experiment):

Melamine polyphosphate (Melapur P200, from DSM Melapur)

Component C:

Melamine cyanurate.

Component D:

Chopped glass fiber of thickness 10 μm.

| | 1 | 2 | 3 | 4 (c)¹ | 5 | 6 | 7 |
|---|---|---|---|---|---|---|---|
| A1 | 55 | 55 | 55 | 55 | | | |
| (% by weight) | | | | | | | |
| A2 | | | | | 50 | 50 | 50 |
| (% by weight) | | | | | | | |
| B1 | 20 | | | | 25 | | |
| (% by weight) | | | | | | | |
| B2 | | 20 | | | | 20 | 10 |
| % by weight) | | | | | | | |
| B3 | | | 20 | | | | |
| % by weight) | | | | | | | |
| B4 | | | | 20 | | | |
| (% by weight) | | | | | | | |
| C | | | | | | | 10 |
| (% by weight) | | | | | | | |
| D | 25 | 25 | 25 | 25 | 25 | 30 | 30 |
| (% by weight) | | | | | | | |
| UL 94 | V-0 | V-0 | V-0 | V-1 | V-2 | V-2 | V-2 |
| 1.6 mm | | | | | | | |

¹Comparative experiment

We claim:

1. A process for preparing phosphorus-nitrogen compounds by reacting phosphorus sulfides with an amino component which
has at least one nitrogen atom having at least two hydrogen atoms, or
has at least two nitrogen atoms having at least one hydrogen atom, which comprises forming the desired phosphorus-nitrogen compounds at a temperature Tₘₐₓ≧200° C.

2. A process as claimed in claim 1, wherein the amino component has been selected from primary aliphatic or aromatic amines, primary or secondary diamines, diimines, primary or secondary ammonium salts, amides of organic or inorganic acids, hydrazines, hydrazides, semicarbazides, semicarbazones, urea, dicyandiamide, melamine, guanidine or its salt, or mixtures of these.

3. A process as claimed in claim 2, wherein the amino component has been selected from urea, dicyandiamide, melamine, guanidine or mixtures of these.

4. A process as claimed in any one of claims 1 to 3, wherein use is made of monomeric phosphorus sulfides of composition P₄Sₙ, where n is from 3 to 10, or mixtures of these.

5. A process as claimed in claim 4, wherein the phosphorus sulfide is P₄S₁₀.

6. A process as claimed in any one of claims 1 to 5, wherein the ratio of sulfur atoms present in the phosphorus sulfides to condensable nitrogen groups present in the amino component is from 1:0.5 to 1:10.

7. A process as claimed in any one of claims 1 to 6, embracing the following steps:
a) heating the phosphorus sulfide and the amino component together to the temperature T₁ under an inert gas, and
b) slowly heating the resultant reaction mixture to Tₘₐₓ≧200° C. under an inert gas.

8. A process as claimed in claim 7, wherein step b) is carried out with addition of from 2 to 20% by weight of zinc oxide.

9. A phosphorus-nitrogen compound which can be prepared by a process of claims 1 to 8.

10. The use of a phosphorus-nitrogen compound as claimed in claim 9 as flame retardant in thermoplastic molding compositions.

11. A thermoplastic molding composition comprising:
a) from 5 to 99% by weight of a thermoplastic polymer, as component A,
b) from 1 to 40% by weight of a compound as claimed in claim 9, as component B,
c) from 0 to 30% by weight of a nitrogen compound, as component C,
d) from 0 to 50% by weight of fillers, as component D,
e) from 0 to 5% by weight of lubricants, as component E,
f) from 0 to 10% by weight of conventional additives, as component F, and
g) from 0 to 30% by weight of conventional impact modifiers, as component G.

12. A process for preparing a thermoplastic molding composition as claimed in claim 11, which comprises mixing components A and B and also, if desired, C to G at an elevated temperature, with melting of component A.

13. The use of a thermoplastic molding composition as claimed in claim 11 for producing moldings, films or fibers.
